(19) United States
(12) Patent Application Publication
(10) Pub. No.: US 2004/0104303 A1
(43) Pub. Date: Jun. 3, 2004

(54) VSTOL VEHICLE

(76) Inventor: Youbin Mao, Pasadena, CA (US)

Correspondence Address: YOUBIN MAO, 430 N. HOLLISTON AVENUE, #210, PASADENA, CA, 91106, US

(21) Appl. No.: 10/012,135

(22) Filed: Nov. 29, 2001

(51) Int. Cl. B64C 29/00

(52) U.S. Cl. 244/12.5

(57) ABSTRACT

A VSTOL vehicle including a fuselage with two pairs of ducted rotors fully enclosed fore and aft of the fuselage respectively. The fuselage is aerodynamically shaped to generate lift in forward flight. All four ducts are configured such that their center axes are substantially parallel to each other, and at an angle tilted sufficiently forward from the vertical axis of the fuselage. Each ducted rotor is powered by one engine inside the duct behind the rotor. All four rotors and engine shafts rotates counterclockwise, generating substantial angular momentum to stabilize the vehicle through the gyroscopic effect. Variable-shape inlets of the ducted rotors and vector thrusting of the airflow out of the ducted rotors combine to provide efficient power and control during all phases of flight. The vehicle is configured to meet motor vehicle requirements to drive on streets.

### FEDERALLY SPONSORED RESEARCH

Not Applicable

### SEQUENCE LISTING OR PROGRAM

Not Applicable

### BACKGROUND—FIELD OF INVENTION

This invention relates generally to vertical or short takeoff and landing (VSTOL) vehicle, specifically to an improved VSTOL vehicle that is stable and capable of high speed cruise with ducted rotors wherein the ducts remain stationary and at an angle between the vertical and longitudinal axes of the vehicle, and the thrusts from the ducted rotors are adjustable and vectored.

### BACKGROUND—DESCRPTION OF PRIOR ART

Ducted rotors, also known as ducted fans, are more efficient and quieter than exposed propellers of the same diameters. They are also safer than exposed propellers on the ground.

Several designs have involved ducted rotors to achieve VSTOL with high-speed cruise capability. The designs have included separate fans for vertical and horizontal thrust (see U.S. Pat. No. 5,890,441); ducted fans mounted in the fixed wings which rotate from horizontal to vertical (see U.S. Pat. No. 3,335,977). These designs suffer from inefficient redundancy, or heavy and complex mechanism that are prone to failure, particularly during transition from hover to flight and vice versa.

A more recent design has four ducted fans fixed on both sides of the fuselage and mounted parallel to the longitudinal axis of the fuselage, and rely on the vanes at the aft part of each ducted fan to redirect airflow for vertical takeoff and landing (see U.S. Pat. No. 5,115,996). This design was intended to achieve efficient high-speed cruise. On closer look, however, such compromise makes vertical take-off inefficient as ninety degree thrust vectoring during takeoff causes significant power loss just when the thrust and power are most needed. Furthermore, bigger ducted fans and more powerful engines are required to push enough airflow to compensate for the power loss due to thrust vectoring during vertical takeoff. Yet bigger fans produce more drag at high-speed cruise, which was what the design was supposed to achieve. Four big fans drawing in air from the front still represents significant safety hazard on the ground. Noise can easily escape from both the front and aft ends of the ducts. Stability control during transition from hovering to forward flight can also be very challenging.

Yet another recent design example is the DuoTrek by Millennium Jet Inc., which has four shallow (depth of the duct substantially smaller than the rotor diameter) ducted fans mounted horizontally on both sides of the fuselage. The design has only a very moderate top speed, as the horizontally mounted and shallow ducted fans are not efficient for high-speed cruise. Noise level will also be necessarily high as the ducts are too shallow to provide much shield.

### OBJECTS AND ADVANTAGES

Therefore several objects and advantages of the present invention are:

(a) to provide a VSTOL design that presents a better compromise between the conflicting requirements of vertical take off and high speed cruise.

(b) to provide a VSTOL design that is inherently more stable and easier to control during all phases of flight, particularly during the transition between hover and forward flight which has been particularly challenging to previous designs.

(c) to provide a VSTOL design that takes full advantage of the potential benefits of ducted rotors;

(d) to provide a VSTOL design that is more efficient in reducing drag and power requirements during all phases of flight.

(e) to provide a VSTOL design that is safe with multiple measures for emergency landing.

(f) to provide a VSTOL design that is quiet.

(g) to provide a VSTOL design that is compact, versatile and capable of multiple use, including meeting motor vehicle requirements to drive on local streets and highways;

(h) to provide a VSTOL design that is capable of flying close to ground much as a hovercraft to take advantage of the ground effect.

Still further objects and advantages will become apparent from a consideration of the ensuing description and drawings.

### SUMMARY

In accordance with the present invention, a preferred embodiment includes a fuselage with two pairs of ducted rotors fully enclosed fore and aft of the fuselage respectively, and two vertical stabilizers attached to the fuselage. The fuselage is configured to generate aerodynamic lift in forward flight. All four ducts are configured such that their center axes are substantially parallel to each other, and at an angle tilted sufficiently forward from the vertical axis of the fuselage. Each ducted rotor is powered by one engine inside the duct behind the rotor.

In the preferred embodiment of the present invention, all four rotors and engine shafts rotate counterclockwise, generating substantial angular momentum to stabilize the vehicle through the gyroscopic effect. Variable-shape inlets of the ducted rotors and vector thrusting of the airflow out of the ducted rotors combine to provide efficient power and control during vertical flight.

### DRAWINGS

### BRIEF DESCRIPTION OF THE DRAWINGS

In the drawings, closely related figures have the same number but diferent alphabetic suffixes.

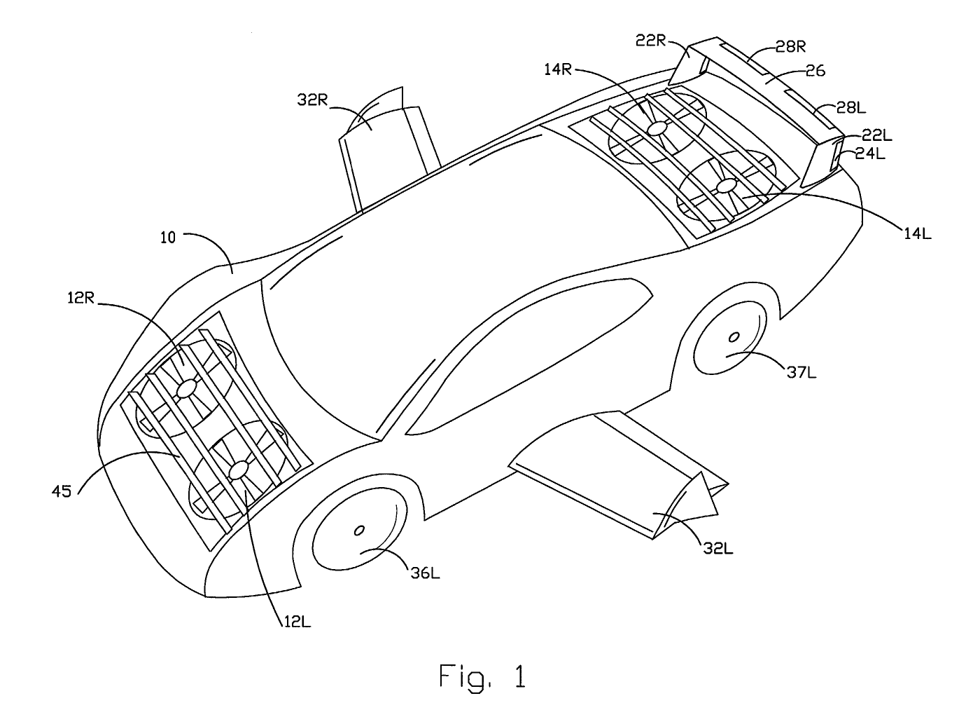

FIG. 1 is a perspective view of a VSTOL vehicle in preferred embodiment in accordance with the present invention.

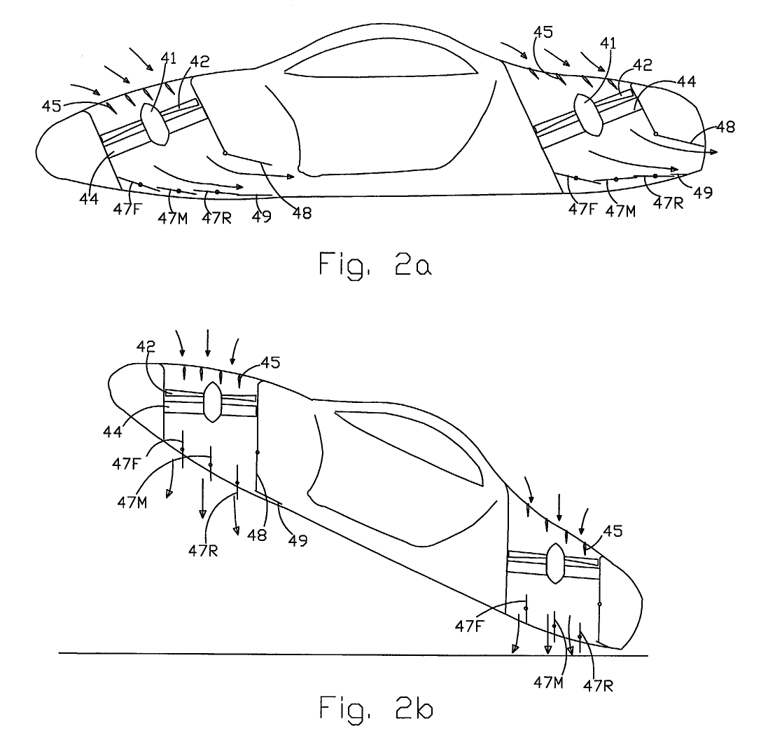

FIG. 2a is a side cross-section view showing relative location and angle from horizontal of the fuselage and the ducted rotor assemblies during typical horizontal flight.

FIG. 2b is a side cross-section view showing relative location and angle of the fuselage and the ducted rotor assemblies in reference to the ground during initial vertical takeoff and in reference to the horizon during vertical flight of the vehicle.

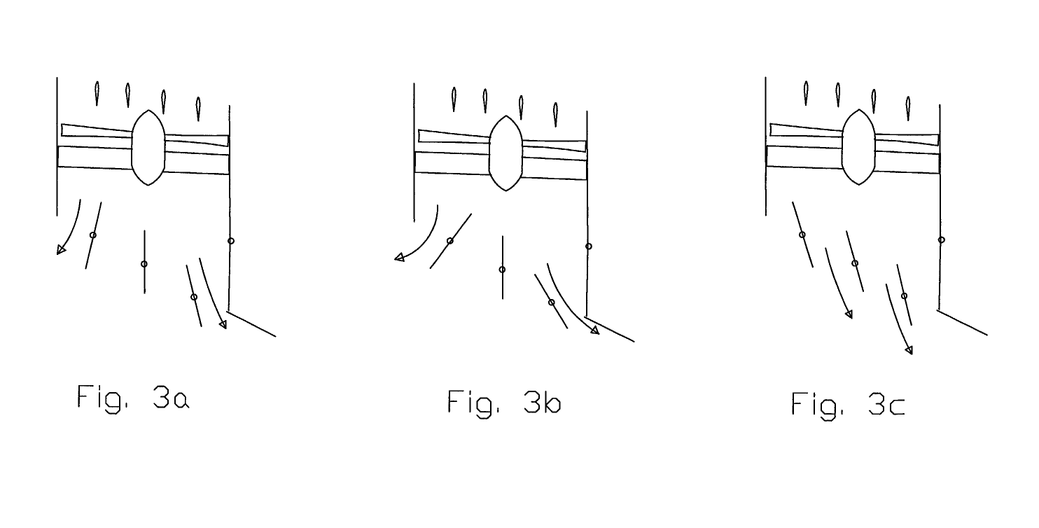

FIGS. 3a-3c illustrate the control of the magnitude and direction of the thrust of one ducted rotor assembly through the exit vanes.

Reference Numerals In Drawings

10 fuselage 12 front ducted rotor assembly

14 rear ducted rotor assembly

22 vertical stabilizer 24 rudder

26 horizontal stabilizer 28 elevator

32 retractable wing

36 front wheel 37 rear wheel

41 engine

42 rotor 44 stators

45 inlet louvers

47 exit vane 48 airflow flap

49 airflow guide

### DETAILED DESCRIPTION OF THE PREFERRED EMBODIMENT

FIG. 1 shows a perspective view of a VSTOL vehicle in the preferred embodiment of the present invention. The preferred embodiment includes an elongated fuselage 10 shaped to produce lift during forward flight, with four ducted rotor assemblies 12L, 12R, 14L, 14R fully enclosed inside the fuselage. Two of the ducted rotor assemblies 12L and 12R are located in the fore of fuselage 10 and forward of the center of gravity of the fuselage, and the other two ducted rotor assemblies 14L and 14R are located in the aft of the fuselage 10 rearward of the center of gravity of the fuselage. Two vertical stabilizers 22L and 22R are respectively attached to and rise from the left and right edges of the rear end of the fuselage 10. Two rudders 24L and 24R are respectively mounted to the rear edges of the two vertical stabilizers 22L and 22R. One horizontal stabilizer 26 is bridged between the top edges of the two vertical stabilizers 22L and 22R, with elevators 28L and 28R mounted to the left and right sides of the rear edge of the horizontal stabilizer 26. A pair of retractable wings 32L and 32R (shown in open position) is hidden underneath the cockpit when not in use.

As illustrated in FIG. 2a, in the horizontal flight mode, the inlets of the ducts are already at an angle to the incoming air stream. In the preferred embodiment, the ducts are installed such that their center axes are parallel to each other and at an angle about 30 degrees forward of the vertical axis of the fuselage. The exiting air is redirected to almost fully horizontal through the exit vanes 47 in each ducted rotor assembly.

FIG. 2b shows the operation of the vehicle in the vertical takeoff or vertical flight mode. The vehicle initially rests on front and rear wheels 36 and 37 (Shown in FIG. 1). To start the vertical takeoff, the exit vanes 47 in the front pair of ducted rotor assemblies 12L and 12R are configured to produce substantial thrust, which lifts the front portion of the vehicle up and rotates around the rear wheels 37, until the longitudinal axis of the fuselage points about 30 degree above horizon, and all four ducted rotor assemblies thrust the airflow straight downward. With all four ducted rotor assemblies in full power mode, the vehicle lifts off.

The detailed structure of a ducted rotor assembly can also be seen in FIGS. 2a and 2b. The present invention requires a “deeply” ducted rotor configuration such that the axial length of the duct is at least half of the diameter of the rotor. Some previous designs employ only a shallow shroud around the rotor. Such configuration is commonly referred to as “shrouded fan” in the art. The more elongated duct in the present invention would allow the incoming air more time to accelerate smoothly and become more evenly distributed when it reaches the rotor, which results in efficient operations at a wide range of cruise speeds.

The cross section of the duct has a rectangular shape at the inlet, and gradually turns into circular shape at the rotor. After that it gradually turns rectangular again for effective thrust control by the exit vanes 47. The cross section area of the duct should be gradually and smoothly reduced from the inlet to the rotor, so the inflow air can be smoothly accelerated toward the rotor without separation.

The engine 41 is of Wenkel rotary type for the following reasons: A rotary engine is more reliable because it has far fewer moving parts than a piston engine. It can also be made more compact than piston engines of the same power. Unlike a piston that rapidly and violently changes direction, the rotor in a rotary engine spins in the same direction, resulting in smoother and quieter operation, as well as more angular momentum for the attitude stability control in the present invention. Each rotor assembly has a number of rotor blades 42, and a number of stators 44 behind the rotor blades. The tips of the rotor blades must be very close to the duct wall for best efficiency. The number of stators is different from the number of rotor blades to reduce vibration. The rotor blades are built with heavier material and strengthened at the tips to maximize angular momentum generated as well as to store sufficient kinetic energy to sustain effective thrust for about three minutes during emergency landing in case of engine failure. The heavier blades also lead to smoother rotation and reduced noise level. The stators have cross sections of airfoil shape and are angled to substantially straighten the airflow that is slightly swirling coming out of the rotor blades. The stators not only convert the swirling energy of the airflow into straight kinetic energy that produces thrust, they also cancel out the torque exerted on the rotor blades by the air.

The inlet has a number of movable louvers 45. The duct exit comprises of three movable exit vanes—front vane 47F, middle vane 47M, and the rear vane 47R, and airflow flap 48 and guide 49.

As shown in FIG. 2a, in the forward flight mode, the inlet louvers 45 tilt forward to guide the incoming air toward the rotor 42. Properly angled, the inlet louvers can minimize the airflow separation around the inlet area during forward flight. The exit vanes 47 are fully extended forward with the airflow flap 48 open to direct all airflow backward.

Refer to FIG. 2b for the operation of the ducted rotor assembly in vertical takeoff and vertical flight mode. The inlet louvers 45 are fully opened to draw in more air, which improves the static thrust. Even the surface area around the inlet now has a lower static air pressure as the air moves toward the inlet, an additional benefit that is not realized by designs with exposed ducts or ducts installed horizontally. The inlet louvers 45 are lined parallel to the duct wall to guide the air straight down toward the rotor 42. The airflow flap 48 is closed. The exit vanes 47 are positioned substantially parallel to the duct wall to guide the airflow straight down. Note that some airflow is intentionally directed towards the front and the rear by 47F and 47R in order to achieve thrust magnitude and direction control as shown in FIGS. 3a-3c.

During the vertical takeoff and vertical flight mode, the control surfaces of the rudders and elevators are ineffective. In the preferred embodiment, all rotor blades have fixed pitch for simplicity and reliability. And the engine power usually cannot be adjusted quickly and dependably for the purpose of stability control. It leaves the exit vanes as the only effective means of thrust control during vertical takeoff and vertical flight.

As shown in FIGS. 3a-3c, the thrust magnitude and direction of a ducted rotor assembly can be effectively controlled by varying the positions of the exit vanes 47F, 47M and 47R.

FIG. 3a illustrates the exit vanes in the neutral position, with 47F and 47R partially redirecting airflow to the front and the back. As shown in FIG. 3b, when 47F and 47R are turned to direct even more air to the front and the back, the net vertical thrust is reduced. To increase the net vertical thrust, 47F and 47R should be turned toward vertical position. FIG. 3c shows 47F, 47M and 47R all turn to direct air partially to the back to product a thrust forward. Note that the angles in FIGS. 3a-3c are exaggerated for better illustrations.

Noting that the present invention utilizes the high angular momentum generated by the rotor assemblies to achieve high stability through the gyroscopic effect, the pitch and roll controls of the vehicle are more similar to those of a helicopter than for a fixed wing aircraft. For example, to pitch forward, a net torque towards the front must be applied. During vertical takeoff and hovering, this is achieved by increasing the vertical thrusts of the two ducted rotor assemblies on the left side (12L and 14L) while reducing the vertical thrusts of the two ducted rotor assemblies on the right side (12R and 14R). The roll control is similarly achieved by using differential vertical thrusts produced by the front pair of ducted rotor assemblies (12L and 12R) and the rear pair of ducted rotor assemblies (14L and 14R). The yaw control is realized by differentially thrusting forward or backward the two ducted rotor assemblies on the left side (12L and 14L) while thrusting in the opposite direction for the two ducted rotor assemblies on the right side (12R and 14R). During full forward flight, all thrusts are directed fully backward, making the attitude control through the thrust vectoring impossible. Thus the conventional control surfaces—the rudders 24L, 24R and the elevators 28L and 28R, takes over the attitude control during forward flight.

The vehicle is also capable of short take off and landing with the conventional control.

The rotor shafts of the front pair of ducted rotor assemblies are connected by a transmission mechanism such that if one engine fails, the remaining engine can still power the two rotors for safe vertical landing. The rotor shafts of the rear pair of the ducted rotor assemblies are similarly connected.

With the retractable wing 32 opened up, the vehicle can extend its cruise range, or stay in the air longer for aerial surveillance. It can also fly close to the ground to take advantage of the ground effect, with the lower sides of the vehicle and the wings providing good air cushion.

The vehicle is designed to float on water, particularly for emergency landing and takeoff.

Advantages

From the description above, a number of advantages of the present invention become evident:

(a) The present invention provides an optimal compromise between the conflicting requirements of vertical takeoff and high-speed cruise. The required maximum engine power of a VSTOL vehicle is determined by the power needed for vertical takeoff. The present invention prevents power loss due to thrust vectoring during vertical takeoff as in some previous designs. Furthermore, the variable inlets opening up to draw in more air during vertical takeoff leads to better lift efficiency, thus further reduces the maximum engine power requirement.

(b) The present invention provides an efficient VSTOL design. The reduced maximum engine power requirement leads to reduced weight of the power system and better fuel efficiency for cruise. Furthermore, without open propellers or exposed external ducts, the present design is more aerodynamic with much less drag, resulting in efficient high-speed cruise. The variable inlet design combined with the deeply embedded rotors allows the rotors to operate at very high efficiency in a wide range of speed. It also opens the design for very high-speed cruise with the more powerful turbo jet engines. A turbo engine happens to provide very high angular momentum with the high rotation rate of its shaft.

(c) The present invention provides a stable and safe VSTOL design. The high angular momentum generated by the rotors and the engine shafts provides the vehicle with very high stability through the gyroscopic effect. The high kinetic energy stored in the rotor blades can also be used for emergency landing. The power redundancy achieved by connecting the front and the rear pair of rotor shafts together with a transmission mechanism provides further security against single engine failure. In an unlikely event that one pair of ducted rotors fails altogether, the vehicle will still be able to fly with the remaining pair of rotors and land on a runway, particularly with the retractable wing open and with the help of the ground effect. And the vehicle can land on water, increasing the chance of a safe landing. Without big wings, and with an aerodynamic body, the vehicle is not susceptible to gust winds. A reliable control system is implemented on triple redundancy computers.

(d) The present invention provides a VSTOL design that is quieter than previous designs. The fuselage provides a better sound insulation than the nacelles of exposed ducted rotors can. The rotary engine and the heavier rotor blades lead to smoother and quieter operation. The deeply embedded rotors allow many active noise suppression technologies to apply. The air is drawn from the top of the fuselage during takeoff, rather than from the front like some other previous designs, resulting in further reduced noise levels.

(e) The present invention provides a VSTOL design that is safe on the ground, without any exposed propellers or nacelles, and without drawing in air from horizontal directions during takeoff.

(f) The present invention provides a VSTOL design that is compact, and can meet the motor vehicle requirements to drive on local streets and highways without much technical difficulties. The purpose is to allow the pilot to drive to and from a place for safe takeoff and landing.

Additional Embodiments

There are many additional embodiments that can demonstrate a variety of applications in accordance with the present invention.

(a) The vehicle in the preferred embodiment has all four rotors rotate in the counterclockwise direction to generate the most angular momentum for stability control. The stators are required to sufficiently straighten the airflow out of the rotor blades. An alternative embodiment relaxes this requirement by rotating the left front (12L) and the right rear (14R) rotors clockwise. A net angular momentum can still be achieved by constructing the left front (12L) and the right rear (14R) rotor blades with lighter materials. This design generates far less angular momentum for stability control and less kinetic energy stored for emergency landing. The benefits include simpler stator design and the ability to achieve yaw control through differential rotation rate or differential pitching between the diagonal pairs of rotors.

(b) A very simple and low cost alternative design deploys counter-rotating rotors as in embodiment (a). Furthermore, four rotors are identical such that they do not generate significant net angular momentum. The variable inlets and thrust vectoring vanes are both optional in this embodiment. The attitude control is completely achieved through differential rotation rate or differential pitching of the four rotors. It is a cost effective design suitable for slower flight applications.

Conclusion, Ramifications, and Scope

Thus it can be seen that the VSTOL vehicle of the present invention provides an efficient, stable, safe, quiet, compact, versatile yet practical design for many potential applications such as public transportation, search and rescue, and military operations.

While my above description contains much specificity, these should not be construed as limitations on the scope of the invention, but rather as an exemplification of one preferred embodiment thereof. Many other variations are possible. For example:

(a) A VSTOL flying disk with three embedded ducted rotors located 120 degree apart. The extreme symmetry in such design makes it highly maneuverable in all direction and less susceptible to any sudden change of the wind direction.

(b) A VSTOL aircraft with two deeply ducted rotors in the fore and aft of the fuselage, with two open propellers horizontally mounted on its wings to provide both yaw control as well as additional propulsion.

Accordingly, the scope of the invention should be determined not by the embodiments illustrated, but by the appended claims and their legal equivalents.

I claim:

1. A VSTOL vehicle comprising:
a fuselage shaped to develop aerodynamic lift in a horizontal flight;
a plurality of ducts, either fully enclosed inside said fuselage, or partially or fully outside said fuselage and rigidly connected to said fuselage, whose center axes are at various fixed angles between said vehicle's vertical and longitudinal axes, each said duct having inside a rotor which rotates about the longitudinal axis of the duct to generate independent streams of airflow for propelling and stabilizing said vehicle, each said duct has a total axial length, as measured from the opening of the duct to its aft end where air flow exits, of at least more than half the diameter of the rotor inside said duct.
a plurality of power plants and transmission means for conveying the rotational energy from said power plants to the said rotors;
control means for controlling the thrusts generated by each said ducted rotor assembly to rotate and move said vehicle in any direction.

2. A VSTOL vehicle as in claim 1 further comprising means for generating and maintaining sufficiently high level of angular momentum to stabilize said vehicle through the gyroscopic effect.

3. A VSTOL vehicle as in claim 1 wherein said rotors and said power plants are designed to store sufficiently high level of kinetic energy to be utilized during takeoff and emergency landing.

4. A VSTOL vehicle as in claim 1 further comprising a plurality of wheels allowing said vehicle to drive on land and transmission means for conveying rotational power from said power plants to said wheels.

5. A VSTOL vehicle as in claim 1 further comprising a plurality of wings retractable inside said fuselage, capable of generating upward lift during forward flight.

6. A VSTOL vehicle as in claim 1 wherein each ducted rotor assembly further comprises a plurality of stators behind the blades of the rotor, wherein said stators are designed to sufficiently straighten the airflow out of the rotor blades, converting rotational energy in the airflow to kinetic energy along the longitudinal axis of the duct.

7. A VSTOL vehicle as in claim 1 wherein the shape of the inlet of each said ducted rotor assembly is variable depending on said vehicle's flight conditions, between one position during takeoff and hover allowing more air to be drawn into the duct, and a second position during forward flight preventing or reducing air separation inside the duct wall.

8. A VSTOL vehicle as in claim 1 wherein each said ducted rotor assembly further comprises an airflow directing vane system located at the aft end of the ducted rotor assembly and movable to redirect partially or all air stream toward any horizontal direction.

9. A VSTOL vehicle as in claim 1 wherein the shape of the side and bottom of said vehicle is designed to utilize the ground effect during takeoff, landing and hover mode near ground.

10. A VSTOL vehicle as in claim 1 wherein the shape and weight of said vehicle is designed to float on water, allowing takeoff and landing on water surface.

11. A VSTOL vehicle comprising:
a fuselage shaped to develop aerodynamic lift in a horizontal flight;
two pairs of ducts, fully enclosed fore and aft of said fuselage respectively, whose center axes are at fixed angles between said vehicle's vertical and longitudinal axes, each said duct having inside a rotor which rotates about the longitudinal axis of the duct to generate independent streams of airflow for propelling and stabilizing said vehicle, each said duct has a total axial length, as measured from the opening of the duct to its aft end where air flow exits, of at least more than half the diameter of the rotor inside said duct.
a plurality of power plants and transmission means for conveying the rotational energy from said power plants to the said rotors;
control means for controlling the thrusts generated by each said ducted rotor assembly to rotate and move said vehicle in any direction.

12. A VSTOL vehicle as in claim 11 further comprising means for generating and maintaining sufficiently high level of angular momentum to stabilize said vehicle through the gyroscopic effect.

13. A VSTOL vehicle as in claim 11 wherein said rotors and said power plants are designed to store sufficiently high level of kinetic energy to be utilized during takeoff and emergency landing.

14. A VSTOL vehicle as in claim 11 further comprising a plurality of wheels allowing said vehicle to drive on land and transmission means for conveying rotational power from said power plants to said wheels.

15. A VSTOL vehicle as in claim 11 further comprising a plurality of wings retractable inside said fuselage, capable of generating upward lift during forward flight.

16. A VSTOL vehicle as in claim 11 wherein each ducted rotor assembly further comprises a plurality of stators behind the blades of the rotor, wherein said stators are designed to sufficiently straighten the airflow out of the rotor blades, converting rotational energy in the airflow to kinetic energy along the longitudinal axis of the duct.

17. A VSTOL vehicle as in claim 11 wherein the shape of the inlet of each said ducted rotor assembly is variable depending on said vehicle's flight conditions, between one position during takeoff and hover allowing more air to be drawn into the duct, and a second position during forward flight preventing or reducing air separation inside the duct wall.

18. A VSTOL vehicle as in claim 11 wherein each said ducted rotor assembly further comprises an airflow directing vane system located at the aft end of the ducted rotor assembly and movable to redirect partially or all air stream toward any horizontal direction.

19. A VSTOL vehicle as in claim 11 wherein the shape of the side and bottom of said vehicle is designed to utilize the ground effect during takeoff, landing and hover mode near ground.

20. A VSTOL vehicle as in claim 11 wherein the shape and weight of said vehicle is designed to float on water, allowing takeoff and landing on water surface.
